(19) United States
(12) Patent Application Publication
(10) Pub. No.: US 2020/0327482 A1
(43) Pub. Date: Oct. 15, 2020

(54) PERSONNEL ASSIGNMENT SUPPORT SYSTEM

(71) Applicant: JTEKT CORPORATION, Osaka-shi (JP)

(72) Inventors: Kazuma SUZUKI, Kariya-shi (JP); Riyo Futamura, Nagoya-shi (JP)

(73) Assignee: JTEKT CORPORATION, Osaka-shi (JP)

(21) Appl. No.: 16/842,866

(22) Filed: Apr. 8, 2020

(30) Foreign Application Priority Data
Apr. 9, 2019 (JP) 2019-074123

(51) Int. Cl. G06Q 10/06; G06Q 50/04

(52) U.S. Cl. CPC G06Q 10/063118; G06Q 50/04; G06Q 10/063112

(57) ABSTRACT

A personnel assignment support system includes a work time period acquiring section that acquires a plurality of work time periods, an evaluating section that stepwisely evaluates a working ability for each of the workers, based on the work time periods acquired by the work time period acquiring section, an ability database that stores a result evaluated by the evaluating section, as a personal ability data for each of the workers, an assignment processing section that executes an assignment program which is executable while referring to the personal ability data, a first display device that displays the personal ability data, and contents processed by the assignment processing section, to a supervisor of the organization, and an announcement device that announces an assignment information to the workers, the assignment information relating to the personnel assignment of the workers which the supervisor determines, by using the assignment program.

### CROSS-REFERENCE TO RELATED APPLICATIONS

This application is based on and claims priority under 35 USC 119 from Japanese Patent Application No. 2019-074123 filed on Apr. 9, 2019, the contents of which are incorporated herein by reference.

### TECHNICAL FIELD

The present disclosure relates to a personnel assignment support system.

### BACKGROUND ART

JP2002-041120A describes a technique for determining the number of workers to be deployed in a work depending on the difficulty of the work, and the skill of the workers. JP2018-180589A describes a technique for evaluating the working ability of a worker in multiple scales.

### SUMMARY OF INVENTION

When a supervisor of a certain organization is to determine assignment of workers belonging to the organization, it takes a lot of time to determine assignment of the workers while considering the working abilities of the workers. On the other hand, there exists a request for efficient assignment of workers.

The present disclosure is to provide a personnel assignment support system that gives support for efficiently assigning workers (hereinafter, “personnel assignment” is often referred to simply as “assignment”).

According to an illustrative aspect of the present disclosure, a personnel assignment support system supports to determine a personnel assignment of a plurality of workers by which an organization is to be formed, the organization producing various products through a plurality of steps. The system includes a work time period acquiring section that acquires a plurality of work time periods that have been required in work for each of the plurality of steps, an evaluating section that stepwisely evaluates a working ability for each of the workers, based on the work time periods acquired by the work time period acquiring section, an ability database that stores a result evaluated by the evaluating section, as a personal ability data for each of the workers, an assignment processing section that executes an assignment program which is executable while referring to the personal ability data, and which is configured to assign the workers to the steps, a first display device that displays the personal ability data, and contents processed by the assignment processing section, to a supervisor of the organization, and an announcement device that announces an assignment information to the workers, the assignment information relating to the personnel assignment of the workers which the supervisor determines, by using the assignment program.

According to the personnel assignment support system, the assignment processing section can execute the assignment program while referring to the personal ability data, and therefore the supervisor can efficiently perform assignment of the workers. The announcement device announces the assignment information that is determined by the supervisor, to the workers, and therefore the personnel assignment support system can smoothly announce the assignment information to the workers.

### BRIEF DESCRIPTION OF DRAWINGS

FIG. 1 is a diagram of a production facility in which a plurality of production lines are disposed;

FIG. 2 is a functional block diagram of an assignment support system;

FIG. 3 is a functional block diagram of an assignment support apparatus;

FIG. 4 is a functional block diagram of an evaluating section;

FIG. 5 is a table showing an example of five work time periods;

FIG. 6 is a table that is produced based on the table of FIG. 5, and that shows work time periods which are converted for calculating the achievement degree, and the total and average of the five work time periods;

FIG. 7 is a table that is produced based on the table of FIG. 5, and that shows work time periods which are converted for calculating the stability degree, and the total and average of the five work time periods;

FIG. 8 is a table showing examples of personal ability data;

FIG. 9 is a functional block diagram schematically showing an assignment processing section;

FIG. 10 is a functional block diagram showing in detail the configuration of the assignment processing section;

FIG. 11 is a view showing examples of a production schedule list and a first facility information displaying screen;

FIG. 12 is a view showing examples of a worker list and an action plan displaying screen; and

FIG. 13 is a view showing examples of the worker list, a second facility information displaying screen, etc.

### DESCRIPTION OF EMBODIMENTS

### 1. Summary of Production Facility 1

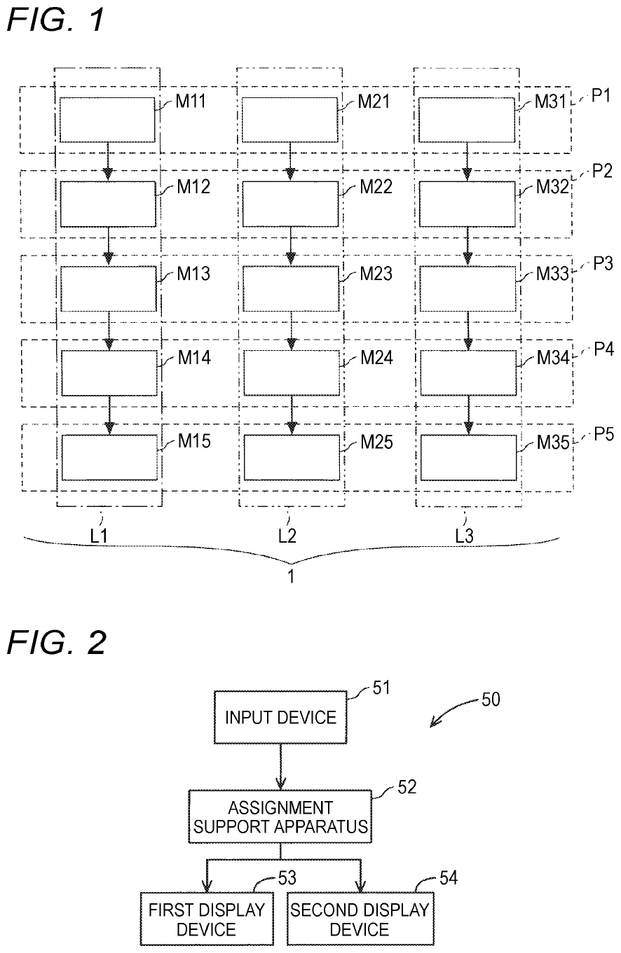

First, a production facility 1 to which an assignment support system 50 is to be applied will be described with reference to FIG. 1. The production facility 1 is used by an organization consisting of a plurality of workers in order to produce various products.

In the production facility 1, as shown in FIG. 1, a plurality of production lines L1 to L3 are disposed, and a plurality of machine tools M are placed in each of the production lines L1 to L3. The supervisor of the organization allocates the workers to the production lines L1 to L3, and the workers operate the machine tools M that are placed in each of the production lines L1 to L3.

The organization produces various products in the production lines L1 to L3. For example, production of automobiles, that of automobile components, that of industrial machines, and the like are performed in the production lines L1 to L3. The organization may simultaneously produce different kinds of products respectively in the production lines L1 to L3, or the same kind of products in the all production lines L1 to L3. Alternatively, the organization may continue to produce the same kind of products in each of the production lines L1 to L3, or may change the kind of products to be produced in accordance with the situation.

In the embodiment, steps of producing products in each of the production lines L1 to L3 includes a first step P1, a second step P2, a third step P3, a fourth step P4, and a fifth step P5. In the first step P1, the workers perform works by using first machine tools M11, M21, and M31. In the embodiment, all of the first machine tools M11, M21, and M31 are of the same kind, and the workers can operate the first machine tools M21 and M31 by an operation method that is similar to the operation method for the first machine tool M11.

In the second step P2, the workers perform works by using second machine tools M12, M22, and M32 to apply works on an intermediate product that is produced in the first step P1. In the embodiment, all of the second machine tools M12, M22, and M32 are of the same kind. In the third step P3, the workers perform works by using third machine tools M13, M23, and M33 to apply works on an intermediate product that is produced in the second step P2. In the embodiment, all of the third machine tools M13, M23, and M33 are of the same kind.

In the fourth step P4, the workers perform works by using fourth machine tools M14, M24, and M34 to apply works on an intermediate product that is produced in the third step P3. In the embodiment, all of the fourth machine tools M14, M24, and M34 are of the same kind. In the fifth step P5, the workers perform works by using fifth machine tools M15, M25, and M35 to apply works on an intermediate product that is produced in the fourth step P4. In the embodiment, all of the fifth machine tools M15, M25, and M35 are of the same kind. A product that is completed in the fifth step P5 is subjected to quality inspection in a quality inspection step that is thereafter conducted.

The number of steps included in each of the production lines L1 to L3 can be arbitrarily set. When there is an unnecessary step with respect to the products that are produced in the production lines L1 to L3, the step may be omitted. The quality inspection step may be conducted not only after the final step, but also between the steps.

### 2. Summary of Assignment Support System 50

Next, the main configuration of the assignment support system 50 will be described with reference to FIG. 2. When various products are to be produced by an organization consisting of a plurality of workers through a plurality of steps, the assignment support system 50 supports the supervisor of the organization to determine assignment of the workers.

As shown in FIG. 2, the assignment support system 50 mainly includes an input device 51, an assignment support apparatus 52, a first display device 53, and a second display device 54 that functions as the announcement device. The input device 51 receives inputs that are performed by the supervisor of the organization. The assignment support apparatus 52 performs various processes in accordance with the contents of the inputs to the input device 51, thereby supporting the supervisor to efficiently perform assignment of the workers.

The first display device 53 is used for displaying the contents of the processes performed by the assignment support apparatus 52. The second display device 54 is used for announcing the worker assignment that is determined by the supervisor of the organization. In the assignment support system 50, the main target for browsing of the display contents displayed on the first display device 53 is the supervisor of the organization, and by contrast that for browsing of the display contents displayed on the second display device 54 is the workers belonging to the organization. Each of the workers views the display contents on the second display device 54 to know the work assigned to the worker, and then moves to the place where the worker is to perform the work.

The first display device 53 and the second display device 54 are not always configured by separate apparatuses, respectively. In the assignment support system 50, namely, a single display device may be used as both the first display device 53 and the second display device 54.

Although, in the embodiment, the assignment support system 50 uses the second display device 54 that can be viewed by the workers, an audio output device or the like may be used as the announcement device for announcing the assignment of the workers, in place of the second display device 54. Namely, the announcement device is required only to announce the assignment to the workers in a manner that the workers can know their respective assigned works. In place of an announcement method in which announcement contents are displayed on a display device such as a large screen, for example, the assignment support system 50 may announce the assignment to the workers by another announcement method such as that in which images, sounds, or the like are transmitted to communication terminals that are carried by the worker. In the case where communication terminals are used as the announcement device, when assignment of a part of the workers is to be changed during work, the assignment support system 50 may individually announce the changed contents of the assignment to the announcement devices that are carried by the part of workers.

### 3. Configuration of Assignment Support Apparatus 52

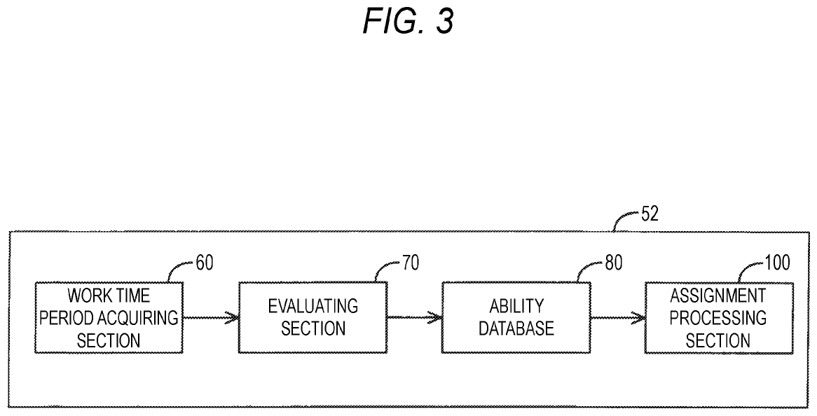

Next, the configuration of the assignment support apparatus 52 will be described with reference to FIG. 3. As shown in FIG. 3, the assignment support apparatus 52 includes a work time period acquiring section 60, an evaluating section 70, an ability database 80, and an assignment processing section 100.

The assignment support apparatus 52 as illustrated in FIG. 3 includes at least one processor and at least one memory. And, the work time period acquiring section 60, the evaluating section 70, the ability database 80, and the assignment processing section 100 are activated by at least one of the processor and the memory, respectively.

In the case where the organization produces a product by using the production facility 1, as shown in FIG. 3, the work time period acquiring section 60 acquires work time periods that are required in the steps P1 to P5, as work performances. In the production facility 1, for example, a start button for indicating the start of a work, and an end button for indicating the end of the work are disposed in each of work areas where respective workers work by using the machine tools M11 to M15, M21 to M25, and M31 to M35. Each of the workers presses the start button when the work in the step handled by the worker is to be started, and presses the end button when the work is ended. Then, the work time period acquiring section 60 acquires the time period from the time when the start button is pressed, to that when the end button is pressed, as the work time period of the corresponding step. The production facility 1 may employ a system that automatically detects the start and end of a work, in place of the start and end buttons.

Alternatively, the assignment support apparatus 52 may acquire a result of a quality inspection that is conducted on products which are produced in the production lines L1 to L3, as work performances. In the alternative, the assignment support apparatus 52 acquires inspection result information that is input by a worker who conducts the quality inspection. The quality inspection includes a plurality of inspection items, and inspection results are indicated for the items, respectively. For example, a measurement value that is obtained in the case where a measurement relating to a product is conducted in the quality inspection is compared with a preset threshold, and, if the inspection result is good, the result is indicated by “∘”, and, if the inspection result is not good, indicated by “x”.

In this case, the inspection items included in the quality inspection are correlated with the production steps. In the case where an inspection item is not good, namely, the supervisor of the organization can estimate that any kind of failure occurs in a production step that is correlated with the inspection item which is determined not to be good. In the case where the first step P1 is correlated with inspection items 1 and 2, when the inspection item 1 or 2 is not good, for example, the supervisor of the organization can estimate that any kind of failure occurs in the first step P1.

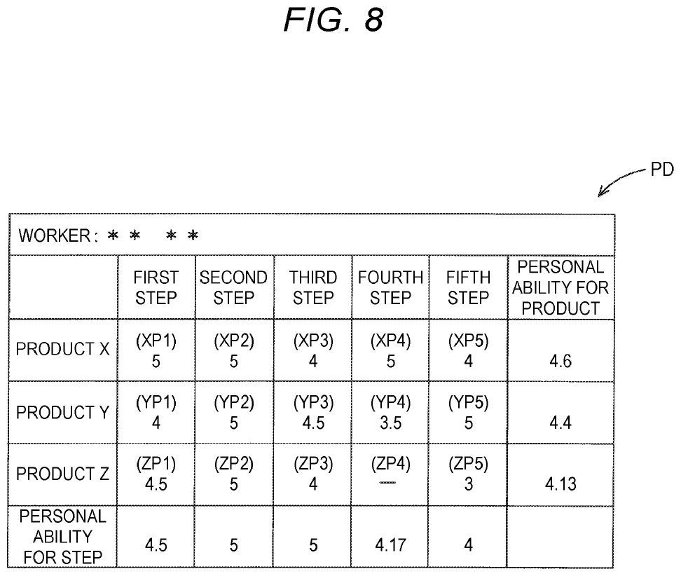

The evaluating section 70 evaluates the working abilities of the workers in a stepwise manner based on the work performances that are acquired by the work time period acquiring section 60. The ability database 80 stores the result of the evaluation performed by the evaluating section, as personal ability data PD (see FIG. 8) for each of the workers. Based on an operation performed by the supervisor of the organization, the assignment processing section 100 executes an assignment program for assigning workers in charge of the steps of producing products. The supervisor may cause the assignment program to be executed, while referring to the personal ability data PD.

### 4. Configuration of Evaluating Section 70

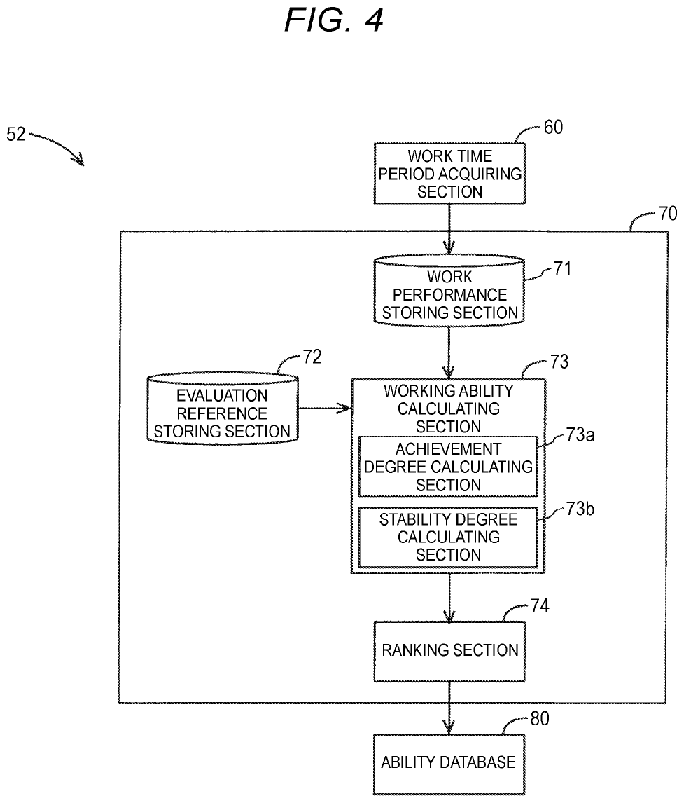

Next, the configuration of the evaluating section 70 will be described with reference to FIG. 4. As shown in FIG. 4, the evaluating section 70 includes a work performance storing section 71, an evaluation reference storing section 72, a working ability calculating section 73, and a ranking section 74.

The work performance storing section 71 stores the work performances such as the work time periods that are acquired by the work time period acquiring section 60. The work performance storing section 71 further stores various work records that are acquired when the organization produces products by using the production facility 1. For example, the work performance storing section 71 stores work dates and times, the names of workers in charge of the steps P1 to P5 in the production lines L1 to L3 (workers who operate the machine tools M11 to M15, M21 to M25, and M31 to M35, respectively), and the like, as the work records. In the case where the assignment of the workers is changed in the same working day, the work time period may be stored in the work performance storing section 71.

The evaluation reference storing section 72 stores reference work time periods that function as indications of the work time periods in the steps P1 to P5, as evaluation references that will be used in evaluation of the work performance. For example, the reference work time periods are arbitrarily set by the supervisor of the organization or the like. The supervisor or the like may set the reference work time periods of the steps P1 to P5 for each of products.

The working ability calculating section 73 executes a preset calculation process by using a computer, based on the work performances stored in the work performance storing section 71, and the reference work time periods stored in the evaluation reference storing section 72, thereby calculating the working abilities of the respective steps for each of products. Each of the working abilities is an index indicating the ratio of the actual work time period that is acquired as the work performance, to the reference work time period, and a value showing an evaluation result of the work performance.

Specifically, the working ability calculating section 73 includes an achievement degree calculating section 73a and a stability degree calculating section 73b. The achievement degree calculating section 73a calculates the achievement degree of the work time period with respect to the reference work time period based on a plurality of work performances that are acquired during a predetermined time period, and the reference work time period. The stability degree calculating section 73b calculates the stability degree of the work time period with respect to the reference work time period based on the plurality of work performances that are acquired during the predetermined time period, and the reference work time period. Namely, the working ability calculating section 73 calculates, as the work performance in the predetermined time period, the achievement degree indicating the degree by which the work time period required in a certain step reaches the reference work time period, and the stability degree indicating the degree by which the work time period required in the step disperses. In this way, the working ability calculating section 73 calculates the two indexes, or the achievement degree and the stability degree, as the work performance. Hereinafter, the achievement degree and stability degree of the work time period will be described with reference to a specific example.

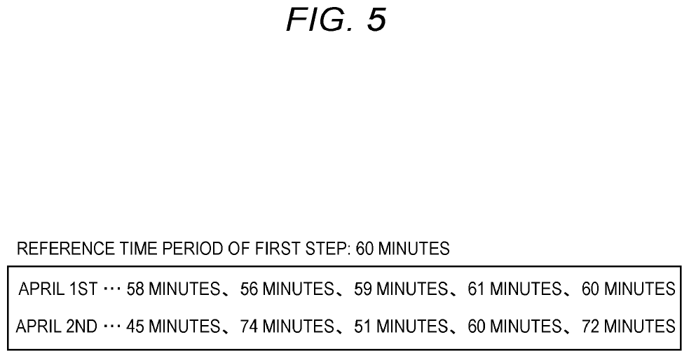

FIG. 5 exemplarily shows work time periods of the first step P1 in the case where a product X is produced. Here, it is assumed that the reference work time period of the first step P1 in the case where the product X is produced is 60 minutes.

In the case where, when the achievement degree is to be calculated, the work time period stored in the work performance storing section 71 reaches the reference work time period, or the actual work time period is within the reference work time period, the achievement degree calculating section 73a converts the actual work time period to the reference work time period, and sets the resulting time period as a work time period for calculation of the achievement degree. In the case where the work time period stored in the work performance storing section 71 does not reach the reference work time period, or the actual work time period exceeds the reference work time period, by contrast, the achievement degree calculating section 73a sets the actual work time period itself as the work time period for calculation of the achievement degree. Then, the achievement degree calculating section 73a calculates the achievement degree by using a plurality of work time periods for calculation of the achievement degree.

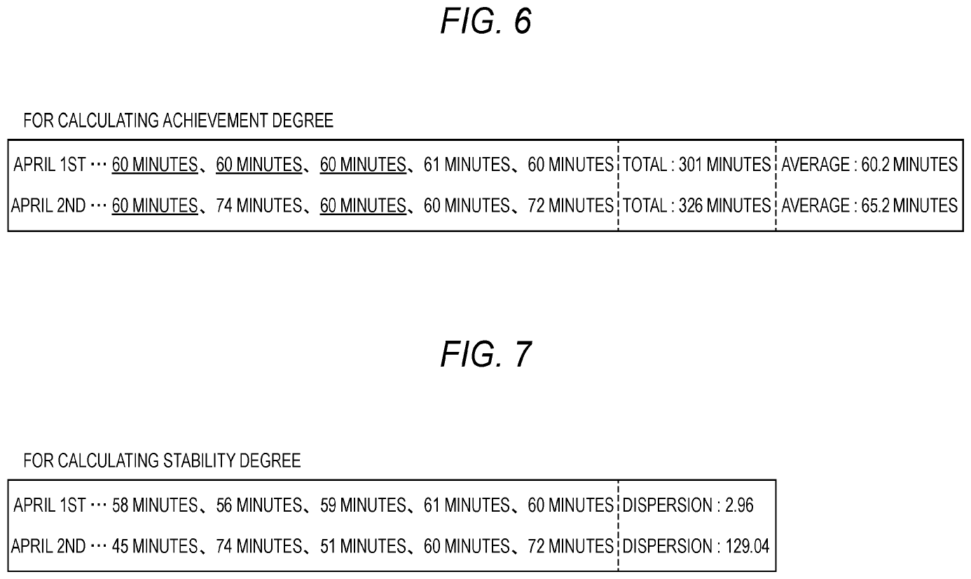

In the example shown in FIG. 5, as shown in FIG. 6, five work time periods of the first step P1 in which the working day is April 1st are 58 minutes, 56 minutes, 59 minutes, 61 minutes, and 60 minutes. In this case, the work time periods for calculation of the achievement degree are converted to 60 minutes, 60 minutes, 60 minutes, 61 minutes, and 60 minutes, respectively. In the example shown in FIG. 5, five work time periods of the first step P1 in which the working day is April 2nd are 45 minutes, 74 minutes, 51 minutes, 60 minutes, and 72 minutes. In this case, the work time periods for calculation of the achievement degree are converted to 60 minutes, 74 minutes, 60 minutes, 60 minutes, and 72 minutes, respectively. This is performed in order to evaluate whether the work time periods of the respective steps reach the reference work time period or not, and to, if there is a work time period that does not reach, evaluate the degree by which the work time period fails to reach the reference work time period.

Then, the achievement degree calculating section 73a calculates the average of the plurality of work time periods that are converted to those for calculation of the achievement degree, as one index of the achievement degree. In the example shown in FIG. 6, the average of the achievement degrees of the first step P1 in which the working day is April 1st is 60.2 minutes, and that of the achievement degrees of the first step P1 in which the working day is April 2nd is 65.2 minutes. With respect to the achievement degree, when the average of the achievement degrees is 60 minutes, this means that all of the achievement degrees reach the reference time period, and the value corresponding to time periods by which the average is longer than 60 minutes means the degree by which the work time periods fail to reach the reference time period.

When the stability degree is to be calculated, by contrast, the stability degree calculating section 73b sets the work time period itself that is stored in the work performance storing section 71, as a work time period for calculation of the stability degree, and calculates the stability degree of a plurality of work time periods by using the work time period for calculation of the stability degree.

In the example shown in FIG. 5, as shown in FIG. 7, five work time periods for calculation of the stability degree of the first step P1 in which the working day is April 1st are 58 minutes, 56 minutes, 59 minutes, 61 minutes, and 60 minutes. In the example shown in FIG. 5, similarly, five work time periods for calculation of the stability degree of the first step P1 in which the working day is April 2nd are 45 minutes, 74 minutes, 51 minutes, 60 minutes, and 72 minutes.

Then, the stability degree calculating section 73b calculates the dispersion of the plurality of work time periods for calculation of the stability degree, as as one index of the stability degree. For example, the dispersion of the stability degree of the first step P1 in which the working day is April 1st is 2.96, and that of the stability degree of the first step P1 in which the working day is April 2nd is 129.04. This means that, with respect to the stability degree, the closer the dispersion of the stability degree to 0, the smaller the variation in work time period, and the higher the stability degree of work time periods.

The ranking section 74 ranks the working ability based on the achievement degree and stability degree of the work time period that are calculated by the working ability calculating section 73. Specifically, the ranking section 74 determines a level as the achievement degree (hereinafter, the level is referred to as “achievement degree level”) by using the average as the achievement degree. The achievement degree level is divided into a plurality of stages (for example, five stages). In the embodiment, when the average as the achievement degree has a small value, the ranking section 74 determines that the achievement degree level is high, and gives a high rank (for example, Level 5). When the average as the achievement degree has a large value, by contrast, the ranking section 74 determines that the achievement degree level is low, and gives a low rank (for example, Level 1).

Although, in the above, the example in which an average is used as one index of the achievement degree has been described, a statistic value other than an average may be used. With respect to the achievement degree, for example, a statistic value that can indicate only achievement/nonachievement may be used.

The ranking section 74 further determines a level as the stability degree (hereinafter, the level is referred to as “stability degree level”) by using the dispersion as the stability degree. The stability degree level is divided into a plurality of stages (for example, five stages). In the embodiment, when the dispersion as the stability degree has a small value, it is determined that the stability degree level is high, and gives a high rank (for example, Level 5). When the dispersion as the stability degree has a large value, by contrast, the ranking section 74 determines that the stability degree level is low, and gives a low rank (for example, Level 1). Although, in the above, the example in which a dispersion is used as one index of the stability degree has been described, a statistic value other than a dispersion may be used.

Then, the ranking section 74 determines the levels of the working ability of the respective steps for each of the products, based on the achievement degree level and the stability degree level. For example, the ranking section 74 ranks the working ability based on the average or total of the achievement degree level and the stability degree level, and the rank of the working ability that is ranked by the ranking section 74 is stored in the ability database 80.

Moreover, the working ability calculating section 73 may calculate the achievement degrees of detection results for a plurality of products. In this case, the ranking section 74 may perform ranking relating to the achievement degrees of the detection results, and determine ranking of the working abilities based on the achievement degrees of the detection results, and the achievement degree and stability degree of the work time period. In this case, the working ability calculating section 73 may set not only the work time period, but also the quality of a produced product as an evaluation target of the working ability.

### 5. Specific Example of Personal Ability Data PD

Next, personal ability data PD that are stored in the ability database 80 will be described with reference to FIG. 8. FIG. 8 shows the personal ability data PD of a worker that are produced based on work performances which are acquired by the work time period acquiring section 60 during a predetermined time period, as an example of the personal ability data PD. In the example shown in FIG. 8, the workers produce three kinds of products X, Y, and Z. The products X and Y are produced through five steps or the first step P1 to the fifth step P5, and the product Z is produced through the four steps other than the fourth step P4. In other words, the fourth step P4 is not included in the production steps for the product Z.

In the example shown in FIG. 8, the average of the rank XP1 of the first step P1 in the case where the product X is produced, the rank YP1 of the first step P1 in the case where the product Y is produced, and the rank ZP1 of the first step P1 in the case where the product Z is produced is stored in the personal ability data PD as the working ability of the worker with respect to the first step P1. Similarly, the average of the rank XP2 of the second step P2 in the case where the product X is produced, the rank YP2 of the second step P2 in the case where the product Y is produced, and the rank ZP2 of the second step P2 in the case where the product Z is produced is stored in the personal ability data PD as the working ability of the worker with respect to the second step P2. In a similar manner, hereinafter, the working abilities of the worker with respect to the third step P3, the fourth step P4, and the fifth step P5 are stored in the personal ability data PD.

In the personal ability data PD, also the dispersion, standard deviation, and the like of the ranks XP1, YP1, and ZP1 of the first step P1 in the case where the products X, Y, and Z are produced may be stored as the working ability of the worker with respect to the first step P1.

In the example shown in FIG. 8, moreover, the average of the rank XP1 of the first step P1, rank XP2 of the second step P2, rank XP3 of the third step P3, rank XP4 of the fourth step P4, and rank XP5 of the fifth step P5 in the case where the product X is produced is stored in the personal ability data PD as the working ability of the worker with respect to the product X.

Similarly, the average of the rank YP1 of the first step P1, rank YP2 of the second step P2, rank YP3 of the third step P3, rank YP4 of the fourth step P4, and rank YP5 of the fifth step P5 in the case where the product Y is produced is stored in the personal ability data PD as the working ability of the worker with respect to the product Y. Furthermore, the average of the rank ZP1 of the first step P1, rank ZP2 of the second step P2, rank ZP3 of the third step P3, and rank ZP5 of the fifth step P5 in the case where the product Z is produced is stored in the personal ability data PD as the working ability of the worker with respect to the product Z.

As described above, the personal ability data relating to the working abilities of the workers belonging to the organization are stored in the ability database 80. Also the dispersion, standard deviation, and the like of the ranks XP1 to XP5 of the steps P1 to P5 in the case where the product X is produced, the ranks XP1 to XP5 of the steps P1 to P5 in the case where the product X is produced in the second production line L2, and the ranks XP1 to XP5 of the steps P1 to P5 in the case where the product X is produced in the third production line L3 may be stored in the ability database 80 as the working ability of the worker with respect to the product X.

### 6. Summary of Assignment Processing Section 100

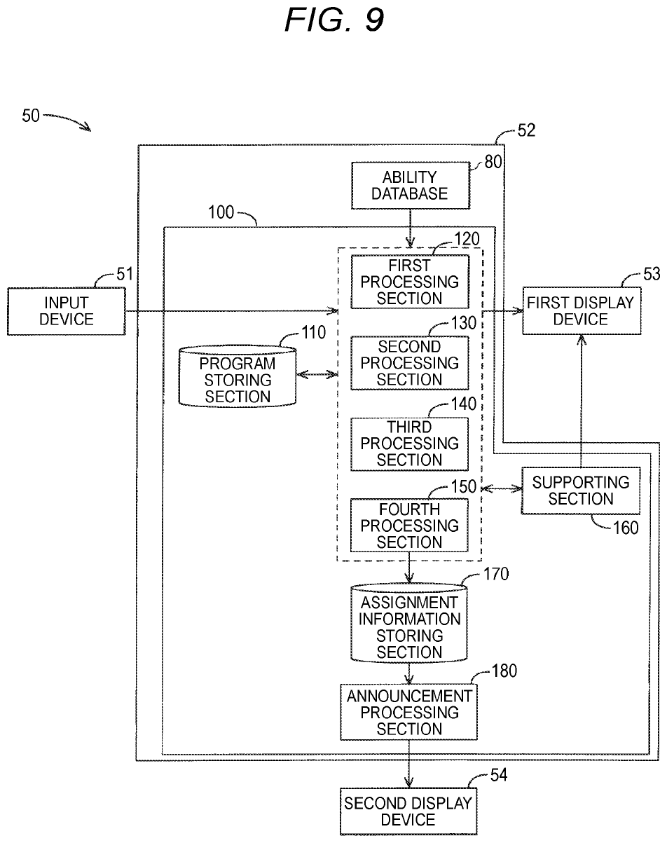

Next, the assignment processing section 100 will be described with reference to FIGS. 9 to 13. As shown in FIG. 9, the assignment processing section 100 includes a program storing section 110, a first processing section 120, a second processing section 130, a third processing section 140, a fourth processing section 150, a supporting section 160, an assignment information storing section 170, and an announcement processing section 180.

The program storing section 110 stores the assignment program for assigning workers to the steps when a product is to be produced. The first processing section 120 performs an initial process for assigning workers to the steps by using the assignment program. The second processing section 130 performs a process for determining steps in which the machine tools M disposed in the production facility 1 are used, based on a production schedule. The third processing section 140 performs a process for determining an action plan of each of the workers based on the production schedule. The fourth processing section 150 mainly performs a process for finally determining the assignment of the workers to the steps. The supporting section 160 supports the supervisor to determine the assignment of the workers. The first processing section 120, the second processing section 130, the third processing section 140, the fourth processing section 150, and the supporting section 160 will be described later in detail.

The assignment information storing section 170 stores assignment information relating to the assignment of the workers that is determined by the supervisor by using the assignment program. The announcement processing section 180 performs a process for announcing the assignment information stored in the assignment information storing section 170, to the workers. In the embodiment, the announcement processing section 180 performs a process for displaying the assignment information on the second display device 54 functioning as the announcement device. As described above, the second display device 54 functioning as the announcement device announces the assignment information that is determined by the supervisor, to the workers, and therefore the assignment support system can smoothly announce the assignment information to the workers.

Here, the assignment information storing section 170 may store also assignment information that is previously determined by the supervisor based on the future production schedule and action plans of the workers. In this case, the assignment information is stored in the assignment information storing section 170 with correlated with announcement time information relating to the announcement time when the assignment information is to be announced. At a timing when the announcement time comes, the announcement processing section 180 performs a process for announcing the assignment information correlated with the announcement time information, to the workers. Even when no operation is performed by the supervisor and the like, namely, the announcement processing section 180 announces the assignment information to the workers at a timing when the announcement time comes. Therefore, the assignment support system 50 can reduce the work burden imposed on the supervisor.

(6-1. Configuration of First Processing Section 120)

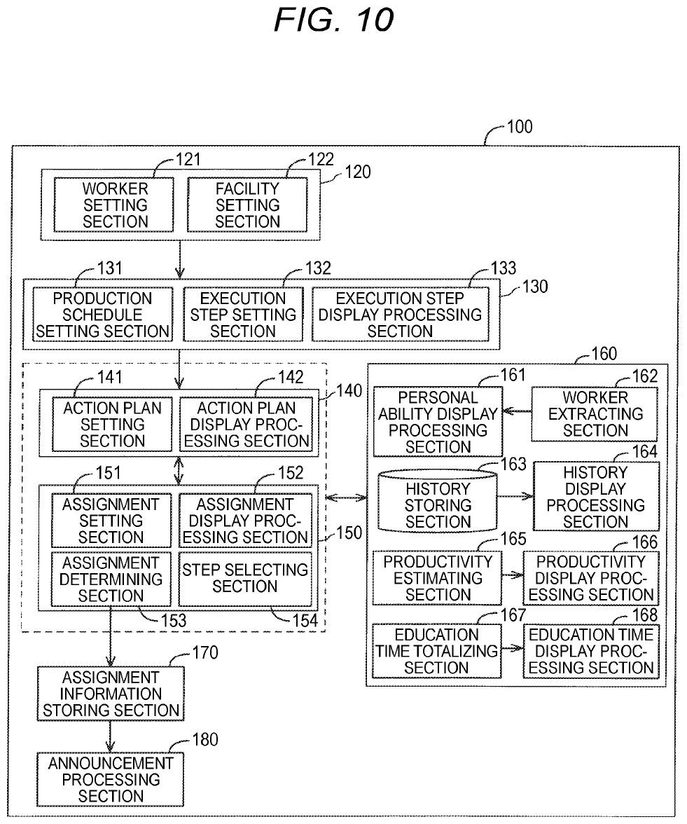

Then, the configuration of the first processing section 120 will be described with reference to FIG. 10. As shown in FIG. 10, the first processing section 120 includes a worker setting section 121 and a facility setting section 122. The worker setting section 121 registers a worker belonging to the organization, in accordance with the contents of an input to the input device 51. The facility setting section 122 registers the machine tools M disposed in the production facility 1, in accordance with the contents of an input to the input device 51. Although, in the embodiment, an example in which one step is performed by using one machine tool M will be described, a plurality of steps may be performed by using one machine tool M.

(6-2. Configuration of Second Processing Section 130)

Next, the configuration of the second processing section 130 will be described. As shown in FIG. 10, the second processing section 130 includes a production schedule setting section 131, an execution step setting section 132, and an execution step display processing section 133.

The production schedule setting section 131 performs a process for setting the production schedule in the organization, in accordance with the contents of an input to the input device 51. The production schedule that is set in the production schedule setting section 131 is, for examples, steps in the case where a specific product is to be produced. The supervisor inputs production schedule information relating to a production schedule that is prepared based on the order situation of products, by using the input device 51, and the production schedule setting section 131 performs a process for setting the production schedule in accordance with the contents of the input to the input device 51.

According to the contents of an input to the input device 51, the execution step setting section 132 performs a process for setting steps that are performed by using the machine tools M disposed in the production facility 1, for each work day. The execution step setting section 132 correlates the production schedule information relating to the production schedule that is set in the production schedule setting section 131, with facility information relating to the setting situation of the machine tools M that is set in the facility setting section 122, and sets the machine tools M that are to be used when the steps contained in the production schedule are performed.

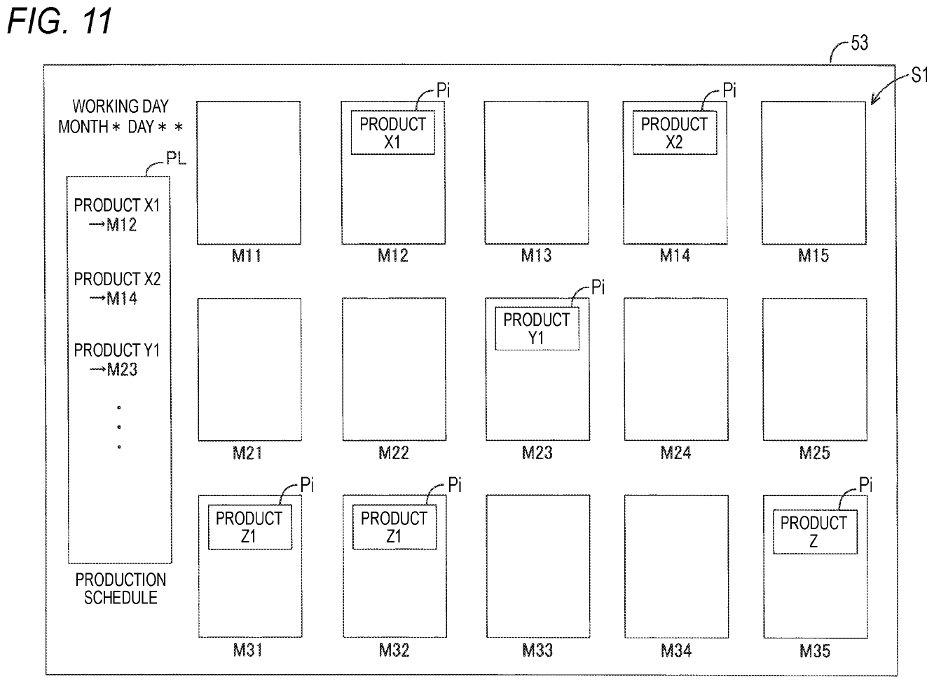

The execution step display processing section 133 performs a process for displaying the set contents that are set in the execution step setting section 132, on the first display device 53. In the example shown in FIG. 11, a production schedule list PL in which the production schedule information is listed is displayed in the left side of the first display device 53 as viewed toward the surface of the sheet, and a first facility information displaying screen S1 on which the correlation situation between the production schedule information and the facility information is shown is displayed on the right side of the production schedule list PL. On the first facility information displaying screen S1, specifically, execution step information Pi related to the step that is executed by each of the machine tools M registered as the facility information is displayed at the position where the machine tool M is displayed. Therefore, the supervisor can know the production schedule of each work day, and the machine tools M that are to be used in the steps which are to be executed based on the production schedule.

(6-3. Configuration of Third Processing Section 140)

Next, the configuration of the third processing section 140 will be described. As shown in FIG. 10, the third processing section 140 includes an action plan setting section 141 and an action plan display processing section 142.

The action plan setting section 141 performs a process for setting the action plan of each of the workers, in accordance with the contents of an input to the input device 51. The action plans that can be set in the action plan setting section 141 contain not only action plans relating to the works that are to be performed in the production facility 1, but also absence information indicating that a specific worker is absent. In addition, the action plans that can be set in the action plan setting section 141 contain in-charge education information (which may be called as an “in-charge trainer information”) indicating that a specific worker is in charge of education of another one(s) of the workers.

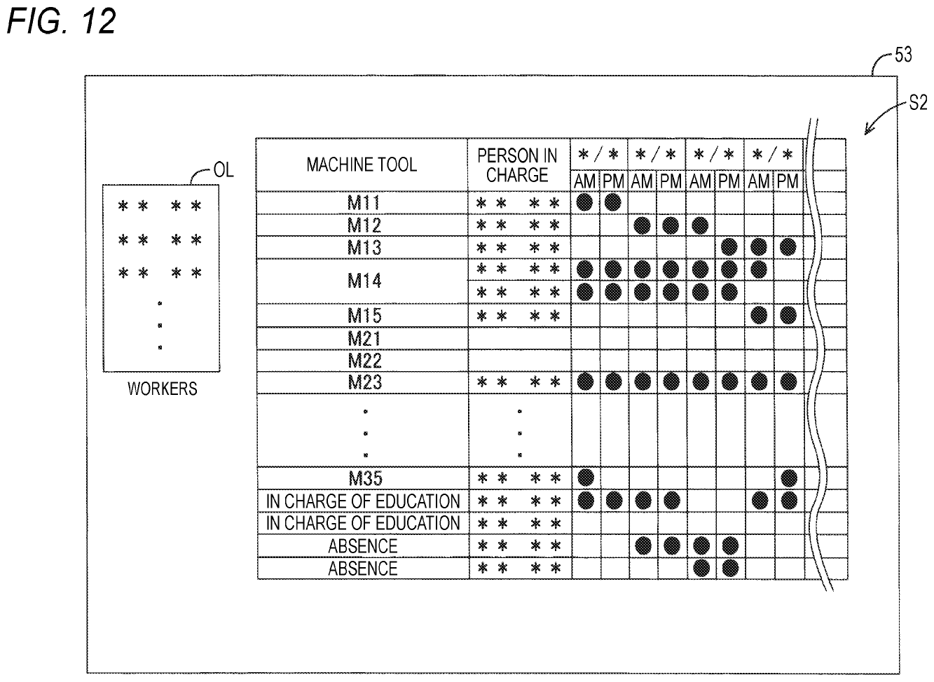

The action plan display processing section 142 performs a process for displaying the action plan in which the setting process performed by the action plan setting section 141 is reflected, on the first display device 53. In the example shown in FIG. 12, a worker list OL in which the workers who are registered in the worker setting section 121 are listed is displayed in the left side of the first display device 53 as viewed toward the surface of the sheet, and an action plan displaying screen S2 indicating action plan information relating to the action plan of each of the workers is displayed on the right side of the worker list OL. In the example shown in FIG. 12, on the action plan displaying screen S2, the action plan information is displayed in work day unit, and action plan information in the morning of each work day, and that in the afternoon are displayed.

As described above, the action plan setting section 141 can set the action plan of each worker containing absence information and in-charge education information. The supervisor can set the action plans of the workers based on the absence information, and therefore the assignment support system 50 can support the determination of the action plans of the workers that is conducted by the supervisor. Moreover, the supervisor can set the action plans of the workers based on the in-charge education information. Namely, the supervisor can set assignment action plans of the workers with respect to the steps while considering training of the workers, and therefore the assignment support system 50 can support determination of efficient assignment that is conducted by the supervisor.

Alternatively, the action plan setting section 141 may perform the process for setting the action plan in work time unit (for example, on an hourly basis), and the action plan display processing section 142 may display action plan information in work time unit (for example, on an hourly basis).

(6-4. Configuration of Fourth Processing Section 150)

Next, the configuration of the fourth processing section 150 will be described. As shown in FIG. 10, the fourth processing section 150 mainly includes an assignment setting section 151, an assignment display processing section 152, and an assignment determining section 153.

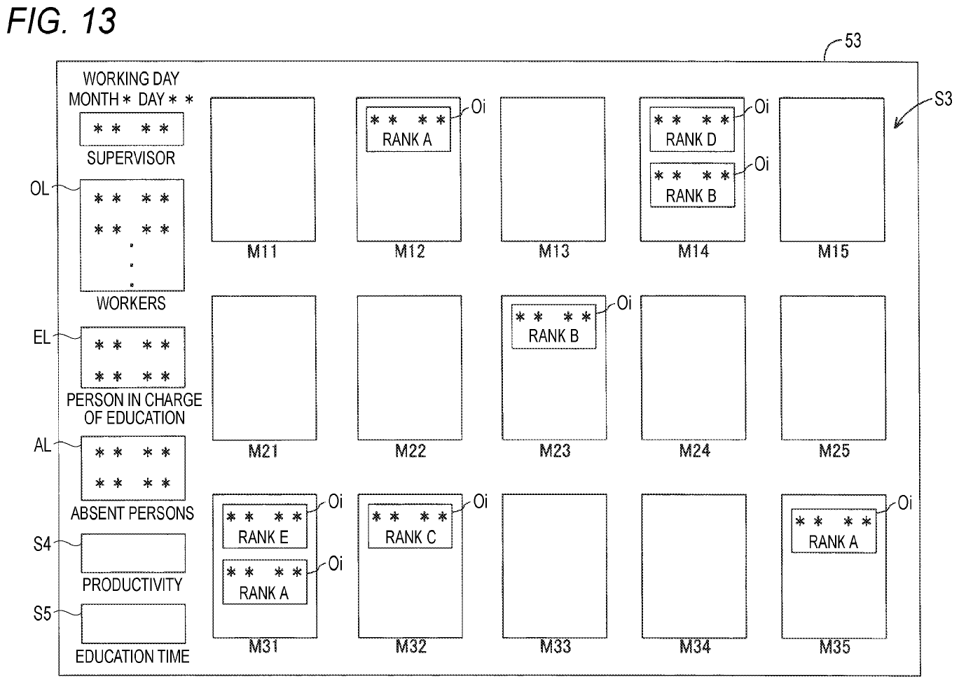

The assignment setting section 151 performs a process for setting workers who are to be assigned to a plurality of steps (machine tools M), in accordance with the contents of an input to the input device 51. The assignment display processing section 152 displays the assignment of workers in which the setting process performed by the assignment setting section 151 is reflected, on the first display device 53. In the example shown in FIG. 13, the work day, the name of the supervisor, the worker list OL, a list of persons in charge of education EL, an absent person list AL, and the like are displayed in the left side of the first display device 53 as viewed toward the surface of the sheet. On the other hand, a second facility information displaying screen S3 on which the correlation situation between the worker assignment information and the facility information is shown is displayed on the right side of the worker list OL and the like. On the second facility information displaying screen S3, specifically, assigned worker information Oi relating to a worker(s) who is assigned to each of the machine tools M registered as the facility information is displayed at the position where the machine tool M is displayed.

When the workers are assigned to the steps that are displayed on the first display device 53, the assignment display processing section 152 causes the ranks of the working abilities of workers in the steps to which the workers are assigned, to be displayed as the assigned worker information Oi.

When a worker is assigned to a step, specifically, the assignment display processing section 152 extracts the personal ability data PD of the worker from the ability database 80. The assignment display processing section 152 further extracts the working ability rank of the worker in the step, and displays the working ability rank on the first display device 53, as the assigned worker information Oi. When the supervisor of the organization checks the assigned worker information displayed on the first display device 53, therefore, the supervisor can know, at a glance, the working ability of the worker assigned to the step. Therefore, the assignment support system 50 can support smooth determination of assignment that is conducted by the supervisor.

Based on an input to the input device 51, the assignment determining section 153 finally determines the worker assignment to the steps. The supervisor can finally determine the assignment while referring to the assigned worker information Oi that is displayed for each of the steps, and therefore the assignment support system 50 can support smooth determination of assignment that is conducted by the supervisor.

Moreover, the assignment determining section 153 causes the worker assignment that is finally determined, to be stored in the assignment information storing section 170 as the assignment information. At this time, the supervisor sets the announcement time when the assignment information is to be displayed on the second display device 54, as the announcement time information, and the assignment determining section 153 causes the assignment information to be stored in the assignment information storing section 170 while correlating the information with the announcement time information. At a timing when the announcement time comes, the announcement processing section 180 displays the assignment information on the second display device 54. At this time, the announcement processing section 180 displays a screen that is similar to the screen displayed on the first display device 53 as the second facility information displaying screen S3, on the second display device 54 as the assignment information.

(6-5. Supporting Section 160)

Next, the supporting section 160 will be described. As shown in FIG. 10, the supporting section 160 includes a personal ability display processing section 161. In accordance with the contents of an input to the input device 51, the personal ability display processing section 161 displays the personal ability data PD of each worker that are stored in the ability database 80, on the first display device 53.

Under a state where the display of the personal ability data PD (see FIG. 8) that is based on the process performed by the personal ability display processing section 161 is conducted on the first display device 53, the assignment setting section 151 can perform the process for setting workers assigned to the steps. Under the state where the display of the personal ability data PD that is based on the process performed by the personal ability display processing section 161 is conducted on the first display device 53, similarly, the action plan setting section 141 can perform the process for setting the action plans of the workers. Namely, the supervisor of the organization can assign the workers to the steps while referring to the personal ability data PD.

As described above, the assignment processing section 100 can execute the assignment program while referring to the personal ability data PD, and therefore the supervisor can efficiently perform assignment of the workers.

The supporting section 160 further includes a worker extracting section 162. The worker extracting section 162 extracts workers who have the working ability in a specific step, from workers whose personal ability data PD are stored in the ability database 80, and the personal ability display processing section 161 displays the result of the extraction performed by the worker extracting section 162, on the first display device 53. In this case, the supervisor can select a worker(s) who is to be assigned to the step, from the workers extracted by the worker extracting section 162. Therefore, the assignment processing section 100 can support determination of efficient assignment that is performed by the supervisor.

The fourth processing section 150 further includes a step selecting section 154. Under a state where the steps (machine tools M) are displayed on the first display device 53 by the assignment display processing section 152, the step selecting section 154 receives a selection of a step (machine tool M) through the input device 51. Namely, the assignment display processing section 152 displays the steps in a manner that one of the steps can be selected by an input to the input device 51, on the first display device 53. When the step is selected, the worker extracting section 162 extracts a worker(s) who has the working ability in the selected step. When the step selecting section 154 receives a selection of a step, as described above, the worker extracting section 162 extracts a worker(s) who has the working ability in the selected step. Therefore, the assignment support system 50 can improve the operability in the operation in which the assignment setting section 151 assigns workers to the steps.

The supporting section 160 further includes a history storing section 163 and a history display processing section 164. The history storing section 163 stores the history of the assignment information that is determined by the assignment determining section 153. The assignment processing section 100 may cause the assignment information that is stored in the assignment information storing section 170, and that has been already subjected to the announcement process by the announcement processing section 180, to be stored in the history storing section 163.

The history display processing section 164 displays the history of the assignment information stored in the history storing section 163, on the first display device 53. Under a state where the display of the history of the assignment information that is based on the process performed by the history display processing section 164 is conducted on the first display device 53, the assignment setting section 151 can execute the process for setting workers to be assigned to the steps. Under a state where the display of the history of the assignment information that is based on the process performed by the history display processing section 164 is conducted on the first display device 53, similarly, the action plan setting section 141 can perform the process for setting the action plans of the workers. Namely, the supervisor of the organization can assign the workers to the steps while referring to the personal ability data PD.

As described above, the supervisor can determine assignment of the workers to the steps while referring to the history of the assignment information, and therefore the assignment support system 50 can support determination of efficient assignment that is conducted by the supervisor. In the case where the supervisor is to determine assignment in a future working day, the supervisor can siphon off the history of the assignment information, and overwrite the siphoned assignment information. In this case, the supervisor can efficiently set assignment of the workers to the steps. Therefore, the assignment support system 50 can support smooth determination of assignment that is conducted by the supervisor.

In the case where new assignment information is displayed on the second display device 54 functioning as the announcement device, the announcement processing section 180 can announce the contents of the change from the immediately previous assignment information, in a manner that the workers can know the changed contents. For example, the announcement processing section 180 compares the immediately previous assignment information that is the history of the assignment information stored in the history storing section 163, and that is stored at last, with the newly to be announced assignment information, and, when the new assignment information is announced, for example, causes the assigned worker information Oi and execution step information Pi that are changed, to be blinking displayed. When the workers check the announced contents displayed on the second display device 54, therefore, each of the workers can easily determine whether the work assigned to the worker is changed or not. As a result, the worker can quickly move to the place where the work is assigned to the worker.

The supporting section 160 further includes a productivity estimating section 165 and a productivity display processing section 166. The productivity estimating section 165 estimates the productivity of the organization based on provisional assignment information that has not yet been finally determined by the assignment determining section 153, and the personal ability data PD. Based on the assignment of the workers to the steps that is set by the assignment setting section 151, specifically, the productivity estimating section 165 estimates the production capacity of the whole organization in the case where works are performed under the assignment.

For example, the productivity estimating section 165 extracts the number of products that are required to be produced in a specific step, from the production schedule information, and also the working abilities of workers who are assigned to the steps, from the personal ability data PD. Then, the productivity estimating section 165 estimates the work time period that is necessary for producing products that are required to be produced in the step. Moreover, the productivity estimating section 165 can estimate also the number of products that can be produced in the step during a predetermined time period (for example, eight hours), based on the work time period that is necessary for one product in each step. In the case where the productivity in a specific working day is to be estimated, the productivity estimating section 165 performs the above-described estimation for all of steps that are to be executed in the working day.

The productivity display processing section 166 displays the result of the estimation performed by the productivity estimating section 165, on the first display device 53. In the example shown in FIG. 13, a productivity displaying screen S4 indicating the estimation result of the productivity is displayed below the absent person list AL.

When the assignment of the workers is to be finally determined, as described above, the supervisor of the organization can study whether the assignment is appropriate or not, while referring to the result of the estimation performed by the productivity estimating section 165. Moreover, the supervisor can correct the assignment of the workers as required. Therefore, the assignment support system 50 can support the final determination of the assignment performed by the supervisor.

The supporting section 160 further includes an education time totalizing section 167 (which may be called as “training time totalizing section”) and an education time display processing section 168 (which may be called as a “training time display processing section”). The education time totalizing section 167 totalizes education times that are consumed for education of the workers in a predetermined time period (for example, one week), based on the in-charge education information that is set in the action plan setting section 141. The education time display processing section 168 performs a process for displaying the result of the totalization of education times that is performed by the education time totalizing section 167, on the first display apparatus 53. In the example shown in FIG. 13, an education time displaying screen S5 indicating the result of the totalization of education times is displayed below the productivity displaying screen S4.

When the assignment of the workers is to be finally determined, as described above, the supervisor of the organization can study whether the assignment is appropriate or not, while referring to the result of the estimation performed by the education time totalizing section 167. Then, the supervisor can correct the assignment of the workers as required. Therefore, the assignment support system 50 can support the final determination of the assignment performed by the supervisor.

### 7. Others

Although, in the embodiment, the case where the assignment processing section 100 executes the assignment program, in accordance with the contents of an input to the input device 51 has been described, the present disclosure is not limited to the embodiment. For example, the assignment processing section 100 may propose an assignment proposal relating to assignment of a worker(s) to each of a plurality of steps, based on the assignment program and the personal ability data PD. For example, the assignment program may extract the number of products that are required to be produced in each of the steps, from the production schedule information, and determine steps to be performed. With respect to each of the steps to be performed, thereafter, the assignment program may assign a worker(s) who is among assignable workers, and who has a working ability in the step which is at a certain level or higher. Then, the assignment program may prepare an assignment proposal in the above-described flow by assigning the workers to the steps, and the assignment processing section 100 may cause the assignment proposal to be displayed on the first display device 53.

At this time, the supervisor of the organization may approve the assignment proposal as it is, and the assignment may be determined by the assignment determining section 153, or the supervisor may correct a part of the assignment proposal, and then the assignment may be determined by the assignment determining section 153. In this case, the supervisor can reduce the effort and time that are necessary for determination of the assignment. Therefore, the assignment support system 50 can support smooth determination of assignment that is conducted by the supervisor.

Although, in the embodiment, the personnel assignment processing section 100 in which, when the step selecting section 154 receives a selection of a specific step, the worker extracting section 162 extracts a worker(s) who has the working ability in the selected step has been exemplarily described, the present disclosure is not limited to the embodiment. For example, the assignment processing section 100 may include an assignment candidate extracting section that extracts assignment candidates of workers for the steps, based on the production schedule and the personal ability data. When the step selecting section 154 receives a selection of a specific step, for example, the assignment candidate extracting section extracts workers who have a working ability in the step which is at a certain level or higher, or top several (for example, three) workers who are high in working ability, as assignment candidates, and the assignment candidates are displayed on the first display device 53. In accordance with the contents of an input to the input device 51, then, the assignment processing section 100 determines a worker(s) to be assigned, from the assignment candidates. Also in this case, the supervisor can reduce the effort and time that are necessary for determination of the assignment, and therefore the assignment support system 50 can support smooth determination of assignment that is conducted by the supervisor.

What is claimed is:

1. A personnel assignment support system for supporting to determine a personnel assignment of a plurality of workers by which an organization is to be formed, the organization producing various products through a plurality of steps, the system comprising:
a work time period acquiring section that acquires a plurality of work time periods that have been required in work for each of the plurality of steps;
an evaluating section that stepwisely evaluates a working ability for each of the workers, based on the work time periods acquired by the work time period acquiring section;
an ability database that stores a result evaluated by the evaluating section, as a personal ability data for each of the workers;
an assignment processing section that executes an assignment program which is executable while referring to the personal ability data, and which is configured to assign the workers to the steps;
a first display device that displays the personal ability data, and contents processed by the assignment processing section, to a supervisor of the organization; and
an announcement device that announces an assignment information to the workers, the assignment information relating to the personnel assignment of the workers which the supervisor determines, by using the assignment program.

2. The personnel assignment support system according to claim 1, wherein the system further comprises an input device that receives an input by the supervisor, and
wherein the assignment processing section executes the assignment program in accordance with contents of the input which the input device receives.

3. The personnel assignment support system according to claim 2, wherein the assignment processing section includes:
an assignment setting section that sets the workers who are to be assigned for each of the plurality of steps, in accordance with the contents of the input which the input device receives; and
an assignment display processing section that displays the personnel assignment of the workers which is set by the assignment setting section, on the first display device.

4. The personnel assignment support system according to claim 3, wherein, when the workers are assigned for each of the steps, the assignment display processing section displays the working ability for each of the workers in the steps to which the workers are assigned.

5. The personnel assignment support system according to claim 3, wherein the assignment processing section further includes:
an action plan setting section that sets an action plan for each of the worker in accordance with the contents of an the input which the input device receives; and
an action plan display processing section that displays the action plan for each of the workers which is set by the action plan setting section, on the first display device, and
wherein the assignment setting section assigns the workers to the steps based on the action plan that is set by the action plan setting section.

6. The personnel assignment support system according to claim 5, wherein the action plan includes an absence information indicating that the worker is absent.

7. The personnel assignment support system according to claim 5, wherein the action plan includes an in-charge trainer information indicating that the worker is in charge of a training of another worker.

8. The personnel assignment support system according to claim 7, wherein the system further comprises:
a training time totalizing section that totalizes a training time that is devoted to the training of the workers in a predetermined period, based on the in-charge trainer information; and
a training time display processing section that displays a result which the training time is totalized by the training time totalizing section.

9. The personnel assignment support system according to claim 3, wherein the system further comprises:
a history storing section that stores a history of the assignment information; and
a history display processing section that displays the history of the assignment information stored in the history storing section, on the first display device.

10. The personnel assignment support system according to claim 9, wherein the assignment setting section is executable to set the workers to the steps, in a state where the history display processing section displays the history on the first display device.

11. The personnel assignment support system according to claim 3, wherein the assignment processing section further includes a personal ability display processing section, and
wherein the personal ability display processing section displays the personal ability data for each of the workers that are stored in the ability database, on the first display device, in accordance with the contents of the input which the input device receives.

12. The personnel assignment support system according to claim 11, wherein the assignment setting section is executable to set the workers to the steps, in a state where the personal ability display processing section displays the personal ability data on the first display device.

13. The personnel assignment support system according to claim 11, wherein the assignment processing section further includes a worker extracting section that extracts at least one of the workers who have the working ability in a specific one of the steps, from among the workers having the personal ability data stored in the ability database, and
wherein the personal ability display processing section is configured to display a result extracted by the worker extracting section.

14. The personnel assignment support system according to claim 13, wherein the assignment processing section further includes a step selecting section,
wherein the step selecting section receives that at least one of the steps is selected through the input device, in a state where the steps are displayed on the first display device by the assignment display processing section, and
wherein the worker extracting section extracts the at least one of the workers who have the working ability in the selected step, when the step selecting section receives that the at least one of the steps is selected.

15. The personnel assignment support system according to claim 3, wherein the system further comprises:
a production schedule setting section that sets a production schedule in the organization, in accordance with the contents of the input which the input device receives; and
an assignment candidate extracting section that extracts candidates from among the workers in the steps for the personnel assignment of the workers, based on the production schedule and the personal ability data, and
wherein the assignment setting section assigns at least one of the workers who are selected from among the candidates extracted by the assignment candidate extracting section, to the steps.

16. The personnel assignment support system according to claim 1, wherein the system further comprises:
a productivity estimating section that estimates a productivity in the organization, based on the assignment information and the personal ability data; and
a productivity display processing section that displays a result estimated by the productivity estimating section, on the first display device.

17. The personnel assignment support system according to claim 1, wherein the assignment processing section provides the supervisor with an assignment proposal relating to the personnel assignment of the workers for each of the plurality of steps, based on the assignment program and the personal ability data.

18. The personnel assignment support system according to claim 1, wherein the evaluating section includes:
a work performance storing section that stores the work time periods which are acquired by the work time period acquiring section, as a work performance;
an evaluation reference storing section that stores a reference work time periods set for each of the steps, the reference work time period being a criterion that is used to evaluate the work time periods;
an achievement degree calculating section that, for each of the steps, calculates an achievement degree of the work time periods with respect to the reference work time period, based on the plurality of work time periods and the reference work time period;
a stability degree calculating section that, for each of the steps, calculates a stability degree of the work time periods with respect to the reference work time period, based on the plurality of work time periods and the reference work time period; and
a ranking section that ranks the working ability, based on the achievement degree and the stability degree.

19. The personnel assignment support system according to claim 1, wherein the announcement device is a second display device that is viewable to the workers.

20. The personnel assignment support system according to claim 1, wherein, in response to changed contents when the contents processed by the assignment information are changed, the announcement device announces the changed contents to the workers in a manner configured to understand the changed contents for the workers.

21. The personnel assignment support system according to claim 1, wherein the system further comprises an assignment information storing section that stores the assignment information which the supervisor determines in advance, to correlate with an announcement time information relating to an announcement time when the assignment information is to be announced, and
wherein at a time when the announcement time reaches, the announcement device announces the assignment information correlated with the announcement time information.

22. A method for supporting to determine a personnel assignment of a plurality of workers by which an organization is to be formed, the organization producing various products through a plurality of steps, the method comprising:
acquiring a plurality of work time periods that have been required in work for each of the plurality of steps;
evaluating stepwisely a working ability for each of the workers, based on the work time periods acquired by the acquiring;
storing a result evaluated by the evaluating, as a personal ability data for each of the workers;
executing an assignment program which is executable while referring to the personal ability data, and which is configured to assign the workers to the steps;
displaying the personal ability data, and contents processed by the executing; and
announcing an assignment information to the workers by using the assignment program, the assignment information relating to the personnel assignment of the workers.

23. A non-transitory computer readable medium storing a program causing a computer to execute a process for supporting to determine a personnel assignment of a plurality of workers by which an organization is to be formed, the organization producing various products through a plurality of steps, the process comprising:
acquiring a plurality of work time periods that have been required in work for each of the plurality of steps;
evaluating stepwisely a working ability for each of the workers, based on the work time periods acquired by the acquiring;
storing a result evaluated by the evaluating, as a personal ability data for each of the workers;
executing an assignment program which is executable while referring to the personal ability data, and which is configured to assign the workers to the steps;
displaying the personal ability data, and contents processed by the executing; and
announcing an assignment information to the workers by using the assignment program, the assignment information relating to the personnel assignment of the workers.

24. A system for supporting to determine a personnel assignment of a plurality of workers by which an organization is to be formed, the organization producing various products through a plurality of steps, the system comprising:
a processor;
wherein the processor is configured to:
acquire a plurality of work time periods that have been required in work for each of the plurality of steps;
evaluate stepwisely a working ability for each of the workers, based on the work time periods acquired by the acquiring;
store a result evaluated by the evaluating, as a personal ability data for each of the workers;
execute an assignment program which is executable while referring to the personal ability data, and which is configured to assign the workers to the steps;
display the personal ability data, and contents processed by the executing; and
announce an assignment information to the workers by using the assignment program, the assignment information relating to the personnel assignment of the workers.
